(19) United States
(12) Patent Application Publication
(10) Pub. No.: US 2012/0133591 A1
(43) Pub. Date: May 31, 2012

(54) PORTABLE MONITOR

(76) Inventors: Jeffrey J. Simmons, Needham, MA (US); Lawrence M. Pensack, Newton, MA (US); Frederic A. Macdonald, Santa Monica, CA (US)

(21) Appl. No.: 13/344,321

(22) Filed: Jan. 5, 2012

Related U.S. Application Data
(63) Continuation-in-part of application No. 12/832,448, filed on Jul. 8, 2010.
(60) Provisional application No. 61/226,759, filed on Jul. 20, 2009.

(51) Int. Cl. G06F 3/02; G06F 1/16

(52) U.S. Cl. 345/169; 361/679.26; 361/679.27

(57) ABSTRACT

Methods, apparatus and other embodiments associated with a portable monitor are presented. The portable monitor includes a monitor base with a rear support brace on the bottom of the monitor base. The portable monitor includes a monitor device with a video screen.

### CROSS REFERENCE TO RELATED APPLICATIONS

This application is a continuation-in-part of U.S. patent application Ser. No. 12/832,448, filed Jul. 8, 2010, which claimed priority from U.S. Provisional Application Ser. No. 61/226,759, filed Jul. 20, 2009; the disclosures of which are incorporated herein by reference.

### BACKGROUND OF THE INVENTION

1. Technical Field

The present invention relates generally to apparatus and systems related to computer monitors. More particularly, the apparatus and systems relate to portable computer monitors. Specifically, the apparatus and systems of the present invention involve a portable computer monitor with a universal hinge and a rear display stand.

2. Background Information

The computation speed and the amount of memory in computers have been dramatically increasing for the past several years. These increases allow a user to increase the number of programs that can be simultaneously run on a single computer. Simultaneously running programs each often generate a separate “window” displayed on a monitor. Similarly, a single program can open several documents or files simultaneously into different windows on the display.

While computers can easily handle the display of multiple windows, the space on a monitor for displaying multiple windows is limited. Windows may be partly or completely overlapping. The user may have to switch between windows. In many instances, it would be more efficient for the user to view two or more windows simultaneously. While the windows can be tiled on the monitor, the size of each window is reduced and may not easily be viewed. One solution is to develop larger monitors that have substantially larger display areas. While these monitors are capable of displaying more windows simultaneously, they generally require more desk space, are heavy and not easy to move around (and are thus more permanent) and are costlier to produce.

Multiple monitors can be used to create a greater area to display windows. Dual monitor systems can be enabled to display multiple windows in each display. In the dual monitor systems, a secondary display controller and associated display are interfaced to the computer in parallel with a primary display controller and associated display. Graphical user interface (GUI) software is commercially available that controls the dual monitors so that the monitors appear as a single correspondingly larger virtual display system, so that curser manipulations and data entry move from screen to screen in a natural manner. For example, one display can display active data entry, while the other can display static reference data such as help screens or other screens. Current operating systems used in personal computers can accommodate multiple monitors.

### BRIEF DESCRIPTION OF THE DRAWINGS

One or more preferred embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates a perspective view of the preferred embodiment of a portable monitor.

FIG. 2 illustrates a top view of the preferred embodiment of the portable monitor.

FIG. 3 illustrates a rear view of the preferred embodiment of the portable monitor.

FIG. 4 illustrates the rotation of the screen of the portable display.

FIG. 5 illustrates another rotation of the screen of the portable display.

FIG. 6 illustrates the fully rotated screen with the portable display in the tablet position.

FIG. 7 illustrates the fully rotated screen with the portable display in an upright position.

FIG. 8 illustrates a rear view of the fully rotated screen with the portable display in an upright position.

FIG. 9 illustrates a method of producing a portable display.

FIG. 10 illustrates an embodiment of another configuration of a portable monitor with an opening for an electronic device in its base.

FIGS. 11-12 illustrate side views of the embodiment of a portable monitor with an opening for an electronic device in its base.

FIG. 13 illustrates a perspective bottom view of the embodiment of a portable monitor with an opening for an electronic device in its base.

FIGS. 14, 15 and 18 illustrate cross-sectional views of the embodiment of a portable monitor with an opening for an electronic device in its base.

FIG. 16 illustrates a perspective bottom view of the embodiment of a portable monitor with an opening for an electronic device in its base as the electronic device is removed from the portable monitor.

FIG. 17 illustrates a perspective view of the embodiment of a portable monitor with an opening for an electronic device in its base with a blank plug device in the opening instead of the electronic device.

FIG. 19 illustrates a perspective view of the embodiment of a portable monitor with an opening for an electronic device in its base with a combination unit in the opening instead of the electronic device.

Similar numbers refer to similar parts throughout the drawings.

### DETAILED DESCRIPTION

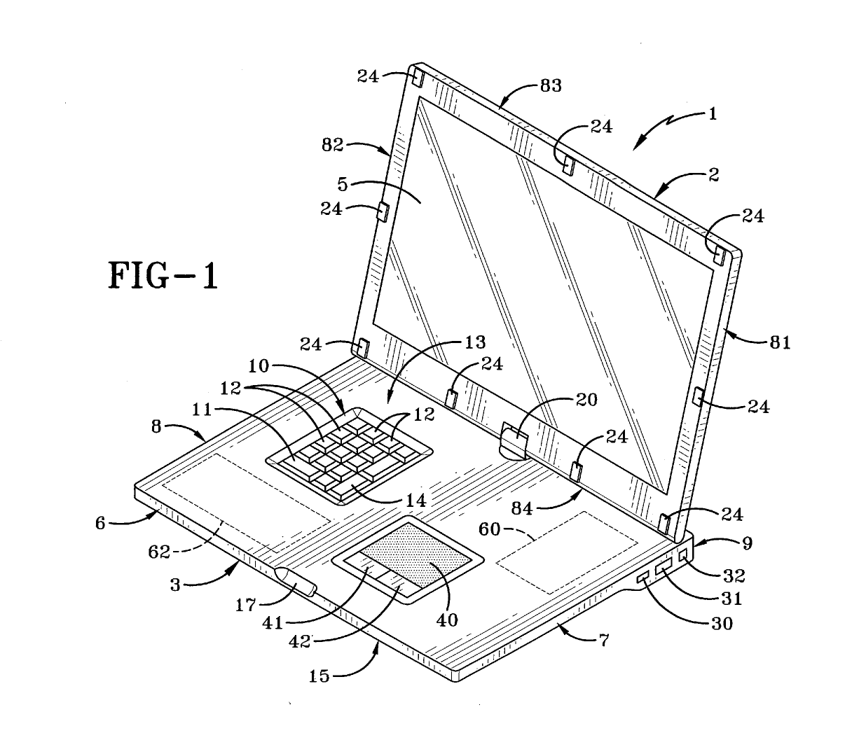

FIG. 1 illustrates a preferred embodiment of a portable monitor 1 that can be connected to a computer as a second monitor. The portable monitor 1 includes a screen device 2 attached to base 3 with a universal hinge 20 (e.g., compound hinge). The base 3 forms a housing that is used to support the screen device 2. The base 3 can be formed similar to housing used in a traditional laptop computer. The base 3 should be shaped and have enough weight to support and balance the screen device 2 when in the open position as shown in FIG. 1. The base 3, screen device 2, and other components of the portable monitor display are generally formed with rigid plastic or other polymer based materials or a metal such as aluminum, but other materials can be used. The base 3 and screen device 2 are generally formed as complementary rectangular shapes with the base 3 having a right side 7, a left side 8, a front side 6, a back side 9 and a bottom surface 15. The screen device 2 has a right side 81, a left side 82, a top side 83 and a bottom side 84. As discussed later, a universal serial bus (USB) port 30, a video input port 31 and/or a jack 32 can be placed in the right side 7 of the base 3. Alternatively, these ports or other auxiliary ports 33, 34, 35 can be placed in the left side 8 of the base 3. For example, port 32 can be a power input plug, port 31 can be a USB-B port and port 30 may be a power on/off switch. Even though the figures illustrate one portable monitor 1, multiple portable monitors could be daisy chained together with one host computer.

In a traditional laptop computer the housing would include a mother board, disk drives, a power supply, and other computer components and electronics. Unlike a traditional laptop computer, the base 3 of the preferred embodiment may contain electronic components for operating a display screen 5 located in the screen device 2, but generally does not include a motherboard or central processing unit (CPU), disk drives, and other computer components. Because the mobile monitor 1 has fewer components than a traditional computer, it can be produced much more economically than a full computer. The display screen 5 can be 15.4″, 15.6″ or a different size.

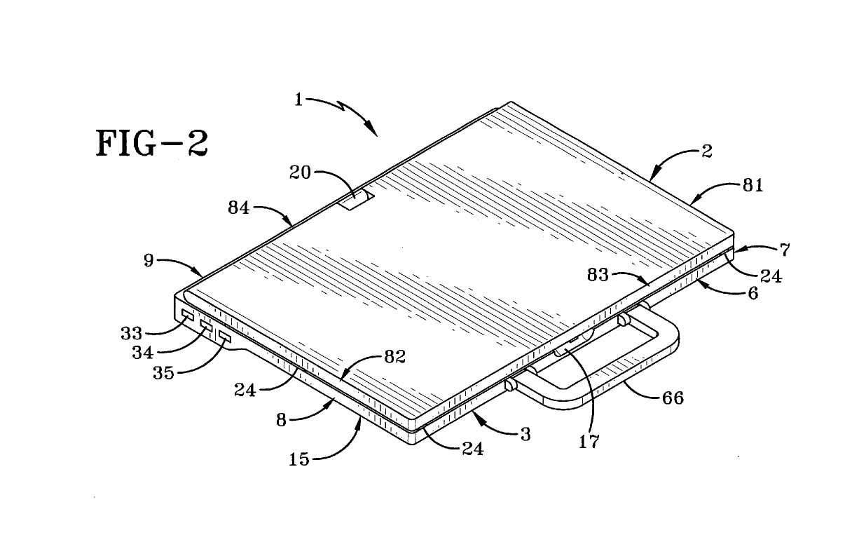

The screen device 2 (e.g. upper portion) and base 3 (e.g. lower portion) are similarly sized so that they can be folded together similar to a laptop computer in a closed folded position shown in FIG. 2. In this position, the portable display can be transported without scratching the display screen 5. In this position the portable monitor 1 is easily transportable, for example, with a laptop in a laptop carrying case or bag. Typically the connection between the base 3 and screen device 2 provides sufficient friction to temporarily keep the base 3 and screen device 2 in the closed position. If necessary or desirable, the portable monitor 1 may further comprise at least one latch 17 in the front side 6 of the base 3 to temporarily keep the base 3 and screen device 2 in the closed position. Alternatively, a recessed area can be formed near the latch 17 or the recessed area can be used to aid in the opening of the portable monitor 1 with or without the latch 17. Similarly, it is possible but not required to have at least one handle 66 (seen in FIG. 2) attached to the portable monitor 1 at either the base 3 and screen device 2, or both.

The screen device 2 and the base 3 are connected together with a universal hinge 20 attached to the bottom side 84 of the screen device and the base 3 that also allows the portable monitor 1 to be configured into a tablet display as discussed later. The screen device 2 generally surrounds the display 5 to protect the display from scratching or damage while the portable monitor 1 is transported.

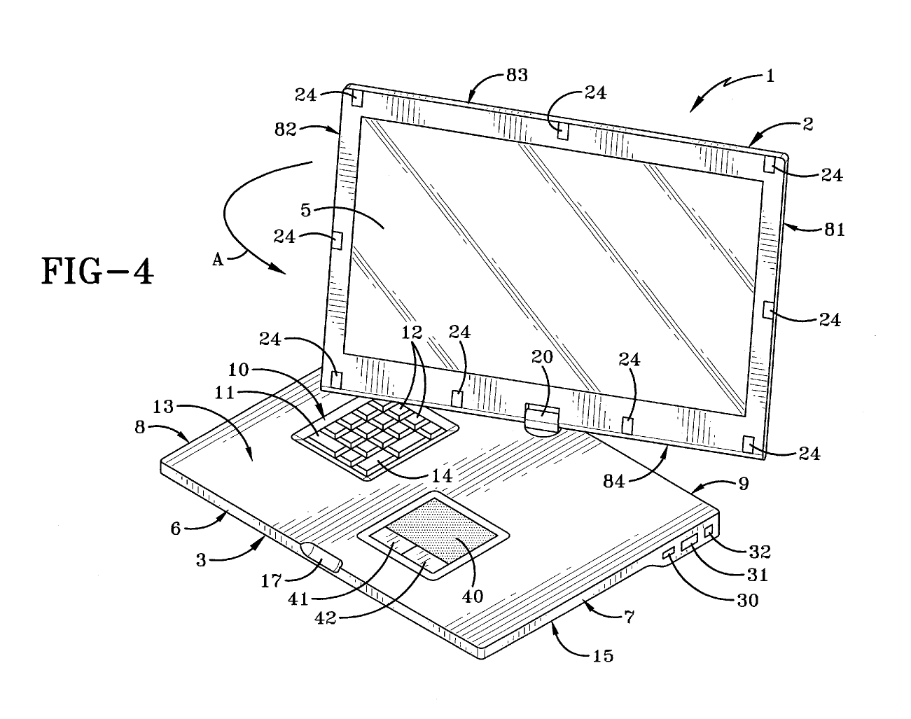

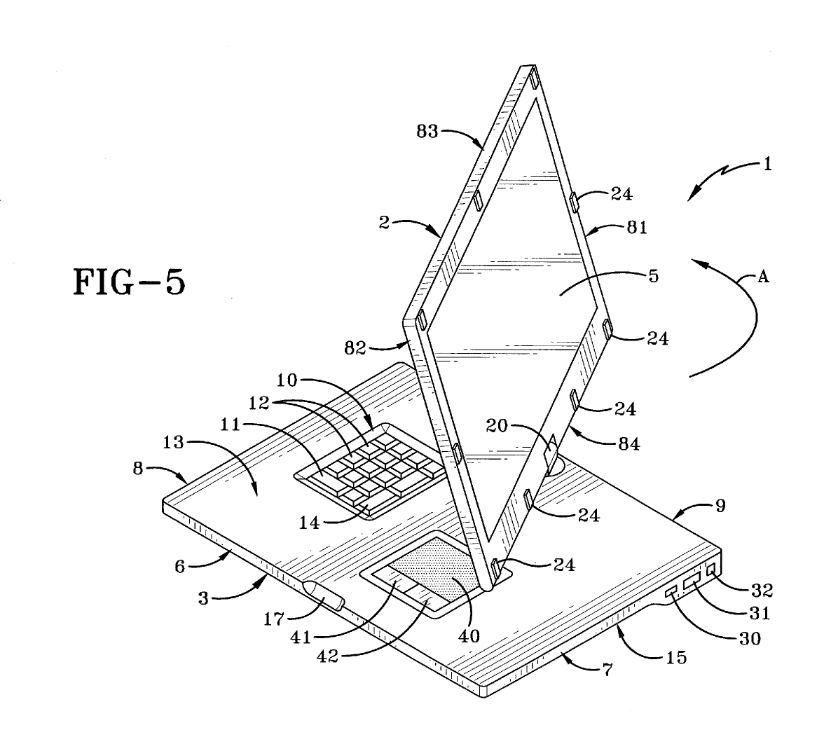

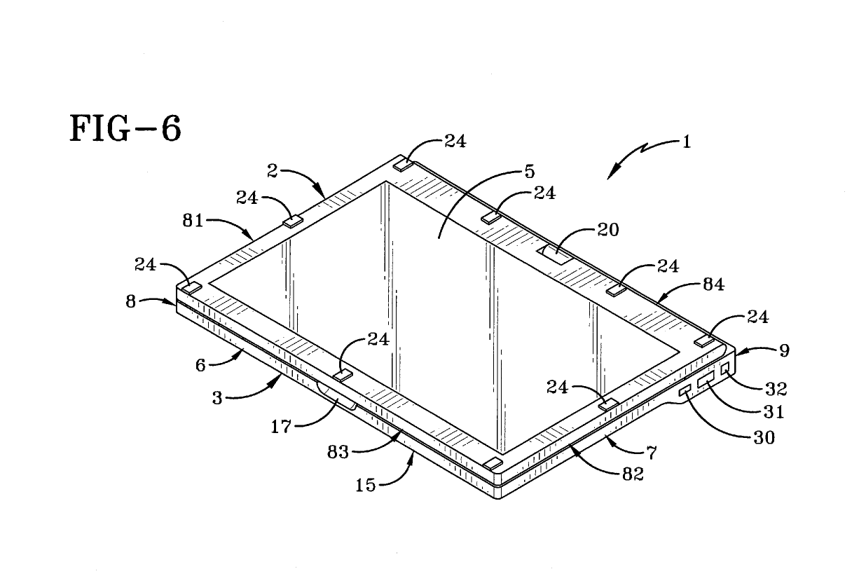

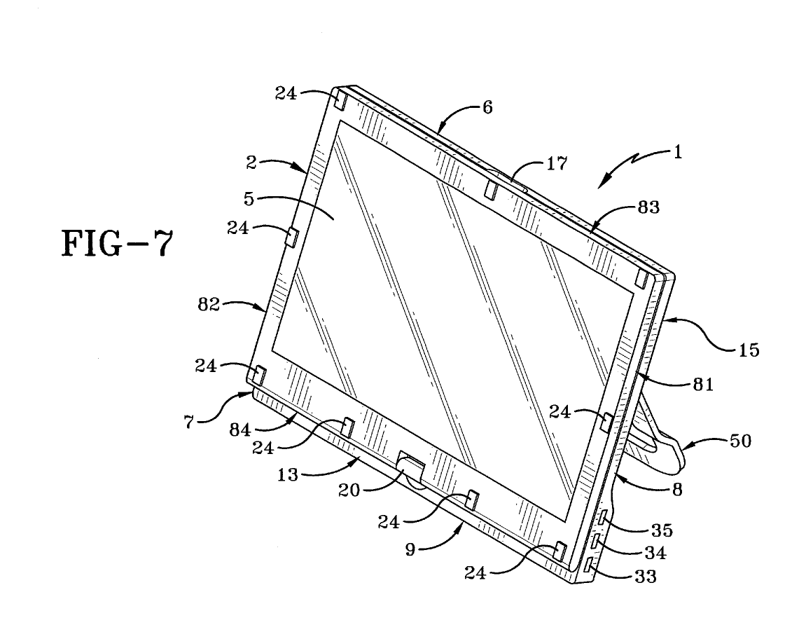

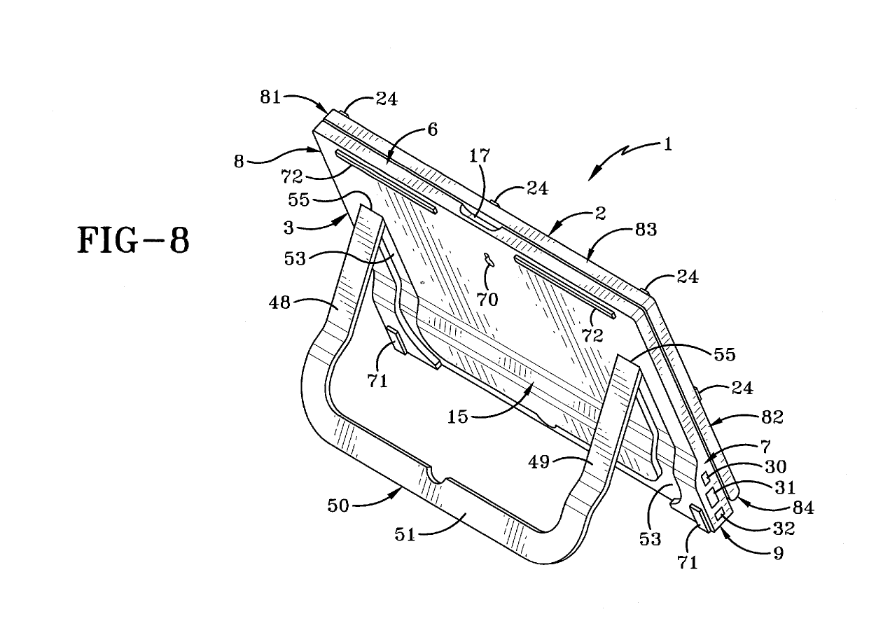

The base 3 also includes a U-shaped rear support brace 50 as shown in FIGS. 7 and 8. The rear support brace 50 includes a left arm 48, a right arm 49 and a center support beam 51 positioned between the left and right arms 48, 49. In the “laptop display position” of FIG. 1, the rear support brace is folded under the base 3 and not used because the base 3 acts to support the screen device. However, as shown in FIGS. 4 and 5, the screen device 2 can be rotated about the universal hinge 20 in the direction of arrow A and then folded into a tablet type of display position as shown in FIG. 6. Of course, the universal hinge 20 can allow the screen device 2 to be rotated in directions different than what is shown by arrow A in the figures. In some embodiments, the hinge 20 may only rotate in one direction. In the tablet position, the right side 81 of the screen device 2 is adjacent to the left side 8 of the base 3. Similarly, the left side 82 of the screen device 2 is adjacent to the right side 7 of the base 3 in the tablet position. In this position, the portable monitor 1 can rest on a desktop surface and be used as a tablet display. Alternatively, the rear support brace 50 can be extracted from the bottom surface 15 of the base 3 so that the portable monitor 1 can be tilted forward and used as an upright monitor as shown in FIGS. 7 and 8. The rear support brace 50 may be pivotally attached to the bottom surface of the base 3 at each end of the rear support brace 50 at two pivot points 55. The pivot points 55 may comprise two pins, hinges, or other pivot mechanisms as understood by those of ordinary skill in the art. The base 3 may have a recessed area 53 that the support brace 50 can be folded into.

In another configuration of the preferred embodiment, the base 3 may include one or more devices for inputting data into a computer the portable monitor 1 is connected to. For example, the portable monitor 1 can include a keypad 10 for entering data into the display. The keypad 10 can include numerical keys 12 for entering numerical digits into the portable monitor 1 and into a computer the portable monitor 1 is connect to. The keypad 10 can include an “enter” button 14 for indicating an entire number is ready to be entered or another function is ready to be performed. The keypad 10 may include other buttons such as one or more function buttons 14 that indicate to a computer that a certain function is to be performed when the function button is pressed. Other input devices that can be used with portable monitor 1, whether incorporated into the base 3 or otherwise connected to the portable monitor 1, include a full QWERTY keyboard, a joy stick, a touch screen, an electronic pen, speakers, or no other device (e.g., a base 3 with no openings). The portable monitor 1 can be connected to and controlled by cell phone such as a Blackberry, iPhone® or another electronic device.

The portable monitor 1 can be configured with a full QWERTY keypad and mouse for use by an individual student in a classroom setting. The portable monitor 1 can be linked to a host computer and act as a “zero client”. Alternatively, the monitor 1 can be daisy chained with other portable monitors 1 or input directly to a host computer. This allows students to log into personal accounts on the host computer, and enter data through the portable monitor 1 which is transmitted, stored, and processed on the host computer. This allows a single classroom to have one host computer and 20 or more “zero client” devices such as portable monitors 1.

In one configuration of the preferred embodiment, as shown in FIG. 1, the base 3 of the portable monitor 1 may include a touchpad 40 (e.g., trackpad) that is a tactile type of sensor. The touchpad 40 can be configured to track the position of a user's finger to position a corresponding curser on the monitor screen 5. The touchpad 40 may be associated with one or more enter 41 and/or select keys 41, 42. These keys 41, 42 may correspond to the left and right mouse keys of a traditional mouse. Traditional laptop computers have a limited area for keys and often only have a basic QWERTY keypad. However, when the portable monitor 1 is attached to a computer, the portable monitor 1 can include the keypad 10, the touchpad 40 or other input devices to enhance the input capabilities of a traditional mobile computer.

The portable monitor 1 will typically need a source of electrical power. Either a conventional external or internal 120 VAC (or equivalent) power supply may be included that is transformed to a desired voltage, or a battery 60 may be located within either or both of the base 3 and screen device 2. As is well known in the art, both rechargeable batteries 60 and a connection to an external power source for charging the batteries 60 and/or powering the display may be employed. It is preferred to place any power-related components within the base 3 so that the weight of such components may add stability to the portable monitor 1 when it is in an open position. It is also possible for the portable monitor 1 to have conventional battery “bays” that accommodate removable batteries 60, either alone or in combination with an external power supply as is common in the art.

The portable monitor 1 also includes a video input port 31 in the right side 7 of the base 3 that is used to receive video data to be displayed on the screen 5. The video input port is capable of receiving audio/video data as well as video data. The portable monitor 1 can be configured to receive one or more formats of video data and to display the video data onto the screen 5. The video data may be in an analog format or a digital format. The video input port 31 can be connected to one end of a suitable cable and the other end of the cable can be connected to another device such as a laptop that is generating the video data to be displayed on the portable monitor 1. One type of cable that may be used for connection to a common laptop computer is a conventional video graphics array (VGA) cable or super VGA (SVGA) cable. Other kinds of audio/video input ports 31 can be used that can connect to other cables such as mini-DIN cables (Deutsches Institute for Normung standard cables), RCA cables, mini-VCA cables, DisplayPort cables, Mini-DisplayPort cables, USB cables and other types of cables. In another configuration of the preferred embodiment, the portable monitor 1 includes a receiver to wirelessly receive audio/video data for display on the screen 5. The portable monitor 1 can receive video data from a variety of electronic devices including computers such as laptop computers, table computers, notebook computers, personal computers, personal digital assistants (PDAs), cellular telephones, internet terminals, gaming devices, personal music or video devices, and other devices that generate video data. In another configuration, the portable monitor 1 can have the capability of sending and receiving wireless data (e.g., numeric and text data entered from the numeric keypad and/or QWERTY keyboard).

In one configuration, the preferred embodiment can include a power saving logic configured to determine if an image displayed on the screen has not changed in a time period. The power saving logic can then cause the portable display to enter a low power mode when the image displayed on the screen has not changed for the time period. For example, the power saving logic can dim the screen 5 to save power. Later, the power saving logic may detect the image displayed on the screen 5 is changing and may apply additional power to the screen.

In another configuration, the portable monitor 1 contains a DisplayLink chip. Of course, those of ordinary skill in the art will appreciate that other chips can be used for controlling and operating the monitor 1. Software that accesses the chips can allow a user to rotate images on the portable monitor 1 to be vertical or “mirror” mode images. The software further has the ability to remember the display configuration as well as previous settings. This allows a user to disconnect the portable monitor 1 from a computer and then later reconnect it to the same computer so that the chip in the portable monitor 1 will remember previous display settings. The DisplayLink chip has controls for adjusting color, resolution, etc which can be accessed through a DisplayLink manager menu. This chip can also implement power saving features to conserve battery life. When a host computer the portable monitor 1 is connected to goes to sleep, the chip senses that and makes similar changes to the portable monitor 1.

In other configurations, the preferred embodiment can include other useful features. For example, the portable device can include controls for adjusting the visual quality (color balance, hue, intensity, and the like) of an image on the screen 5. The image quality may be adjusted by manipulating one or more of the keys 11, 12, 14 on the keypad 10 or via controls 35. In some configurations, the portable monitor 1 can include one or more speakers for generating sound that may be associated with data displayed on the screen 5. Alternatively, the portable monitor 1 can include a jack 32 to connect to an external speaker. The portable monitor 1 may also include an auxiliary connector such as a universal serial bus (USB) to allow a mouse or another device to be connected to the portable monitor 1. Air vents 57 may also be formed in the portable monitor 1 if there is a need for cooling the portable monitor 1. Rubber pads 24 may be placed on the screen device 2 to cushion the screen device 2 onto the base 3 as it is folded onto the base 3 in the closed position. Rubber pads can also be added to the base 3 to protect the back of the screen device 2 when the portable monitor 1 is in the tablet computer position. The portable monitor 1 may include a chamber 62 in the base 3 that allows an electrical cable to be stored in the base 3. The electrical cable can be used to connect the portable monitor 1 to a computer or other electronic device.

The bottom surface 15 of the base 3 may include rubber or other polymer pads 71, 72 attached to the base to prevent the sliding of the portable monitor 1 when it is resting on a surface in the tablet, open laptop or closed positions. The bottom surface 15 may also contain one or more openings 70 to allow the portable monitor 1 to be mounted on a vertical surface such as a wall. The portable monitor 1 can have openings to attach a cable locking device such as a Kensington type of lock. The portable monitor 1 may contain other useful devices such as a built-in video camera for video conferencing (e.g., Skype®), a built-in camera, or other device.

Example methods may be better appreciated with reference to flow diagrams. For the purpose of simplicity of explanation, the illustrated methodologies are shown and described as a series of blocks. It is to be appreciated that the methodology is not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional not illustrated blocks.

FIG. 1 illustrates another preferred embodiment of a portable monitor 1 that can be connected to a computer as a second monitor. The portable monitor 1 includes a screen device 2 attached to base 3 with a universal hinge 20 (e.g., compound hinge). The base 3 forms a housing that is used to support the screen device 2. The base 3 can be formed similarly to the housing used in a traditional laptop computer. The base 3 should be shaped and have enough weight to support and balance the screen device 2 when in the open position as shown in FIG. 1. The base 3, screen device 2, and other components of the portable monitor display are generally formed of rigid plastic or other polymer-based materials or a metal such as aluminum; however, other materials can be used. The base 3 and screen device 2 are generally formed as complementary rectangular shapes with the base 3 having a right side 7, a left side 8, a front side 6, a back side 9 and a bottom surface 15. The screen device 2 has a right side 81, a left side 82, a top side 83 and a bottom side 84. As discussed further below, a universal serial bus (USB) port 30, a video input port 31 and/or a jack 32 can be placed in the right side 7 of the base 3. Alternatively, these ports or other auxiliary ports 33, 34, 35 can be placed in the left side 8 of the base 3. For example, port 32 can be a power input plug, port 31 can be a USB-B port and port 30 may be a power on/off switch. Even though the Figures illustrate one portable monitor 1, multiple portable monitors could be daisy chained together with one host computer.

In a traditional laptop computer, the housing would include a mother board, disk drives, a power supply, and other computer components and electronics. Unlike a traditional laptop computer, the base 3 of the preferred embodiment may contain electronic components for operating a display screen 5 located in the screen device 2, but generally does not include a motherboard or central processing unit (CPU), disk drives, or other computer components. Because the mobile monitor 1 has fewer components than a traditional computer, it can be produced much more economically than a full computer. The display screen 5 can be 15.4″, 15.6″ or a different size.

The screen device 2 (e.g. upper portion) and base 3 (e.g. lower portion) are similarly sized so that they can be folded together similar to a laptop computer in a closed folded position as shown in FIG. 2. In this position, the portable display can be transported without scratching the display screen 5. In this position, the portable monitor 1 is easily transportable, for example, with a laptop in a laptop carrying case or bag. Typically, the connection between the base 3 and screen device 2 provides sufficient friction to temporarily keep the base 3 and screen device 2 in the closed position. If necessary or desirable, the portable monitor 1 may further comprise at least one latch 17 in the front side 6 of the base 3 to temporarily keep the base 3 and screen device 2 in the closed position. Alternatively, a recessed area can be formed near the latch 17 or the recessed area can be used to aid in the opening of the portable monitor 1 with or without the latch 17. Similarly, it is possible but not required to have at least one handle 66 (seen in FIG. 2) attached to the portable monitor 1 at either the base 3, screen device 2 or both.

The screen device 2 and the base 3 are connected together with a universal hinge 20 attached to the bottom side 84 of the screen device and the base 3 that also allows the portable monitor 1 to be configured into a tablet display as discussed later. The screen device 2 generally surrounds the display 5 to protect the display from being scratched or damaged while the portable monitor 1 is transported.

Base 3 also includes an U-shaped rear support brace 50 (shown in FIGS. 7 and 8). Of course, this brace 50 can be L-shaped or other shapes. Rear support brace 50 includes a left arm 48, a right arm 49 and a center support beam 51 positioned between the left and right arms 48, 49. In the “laptop display position” of FIG. 1, the rear support brace is folded under the base 3 and is not used because the base 3 acts to support the screen device. However, as shown in FIGS. 4 and 5, the screen device 2 can be rotated about the universal hinge 20 in the direction of arrow A and then folded into a tablet-type of display position as shown in FIG. 6. Of course, the universal hinge 20 can allow the screen device 2 to be rotated in directions different than what is shown by arrow A in the figures. In some embodiments, the hinge 20 may only rotate in one direction. In the tablet position, the right side 81 of the screen device 2 is adjacent to the left side 8 of the base 3. Similarly, the left side 82 of screen device 2 is adjacent to the right side 7 of base 3 in the tablet position. In this position, the portable monitor 1 can rest on a desktop surface and be used as a tablet display. Alternatively, rear support brace 50 can be extracted from bottom surface 15 of base 3 so that the portable monitor 1 can be tilted forward and used as an upright monitor as shown in FIGS. 7 and 8.

Rear support brace 50 may be pivotally attached to the bottom surface of base 3 at each end of the rear support brace 50 at two pivot points 55. The pivot points 55 may comprise two pins, hinges, or other pivot mechanisms as understood by those of ordinary skill in the art. Base 3 may have a recessed area 53 that the support brace 50 can be folded into.

In another configuration of the preferred embodiment, base 3 may include one or more devices for inputting data into a computer that the portable monitor 1 is connected to. For example, portable monitor 1 can include a keypad 10 for entering data into the display. The keypad 10 can include numerical keys 12 for entering numerical digits into the portable monitor 1 and into a computer that the portable monitor 1 is connected to. The keypad 10 can include an “enter” button 14 for indicating that a number is ready to be entered or another function is ready to be performed. The keypad 10 may include other buttons such as one or more function buttons 14 that indicate to a computer that a certain function is to be performed when the function button is pressed. Other input devices that can be used with portable monitor 1, whether incorporated into the base 3 or otherwise connected to the portable monitor 1, include a full QWERTY keypad, a joy stick, a touch screen, an electronic pen, speakers, or no other device (e.g., a base 3 with no openings). The portable monitor 1 can be connected to and controlled by a cell phone such as a Blackberry®, iPhone® or other electronic device.

The portable monitor 1 can be configured with a full QWERTY keypad and mouse for use by an individual student in a classroom setting. The portable monitor 1 can be linked to a host computer and act as a “zero client”. Alternatively, the monitor 1 can be daisy chained with other portable monitors 1 or input directly to a host computer. This allows students to log into personal accounts on the host computer and input data through the portable monitor 1; this data is then transmitted, stored, and/or processed on the host computer. This allows a single classroom to have one host computer and 20 or more “zero client” devices such as portable monitors 1.

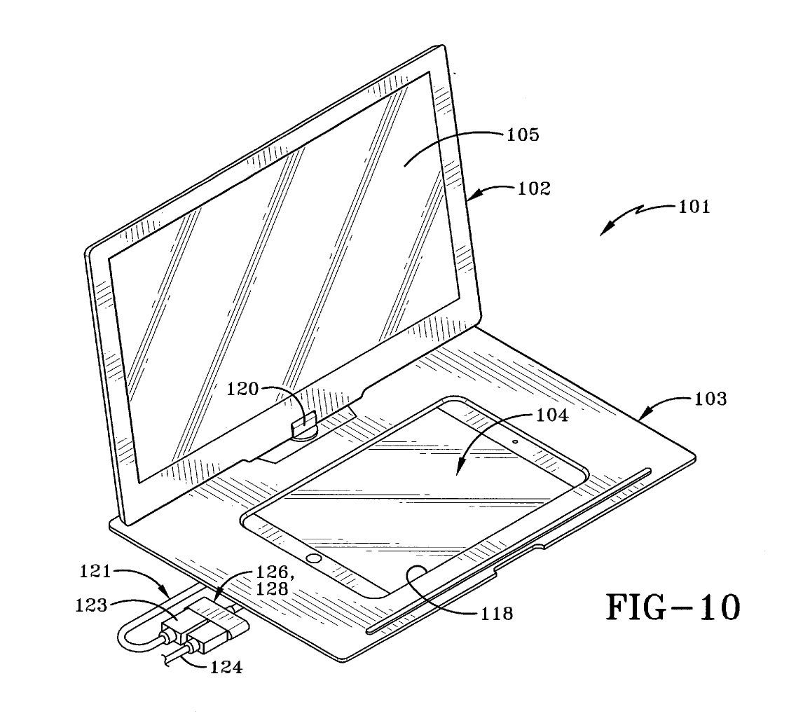

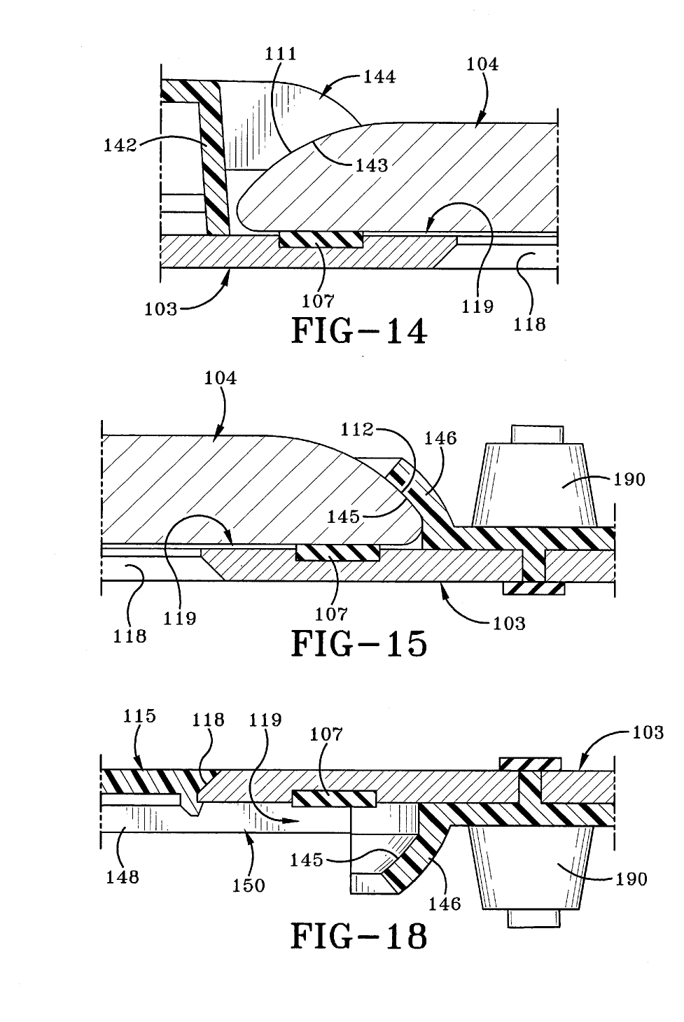

FIGS. 10-18 illustrate a configuration of the preferred embodiment that allow an electronic device 104 such as an iPad® to be inserted into a base 103 of a portable monitor 101. Of course, the electronic device can be any electronic device including an iPhone®, iPod Touch®, a tablet computer, a cellular phone, a handheld electronic device or another device. The graphics of the electronic device 104 can then be displayed on a screen device 102 of the portable monitor 101.

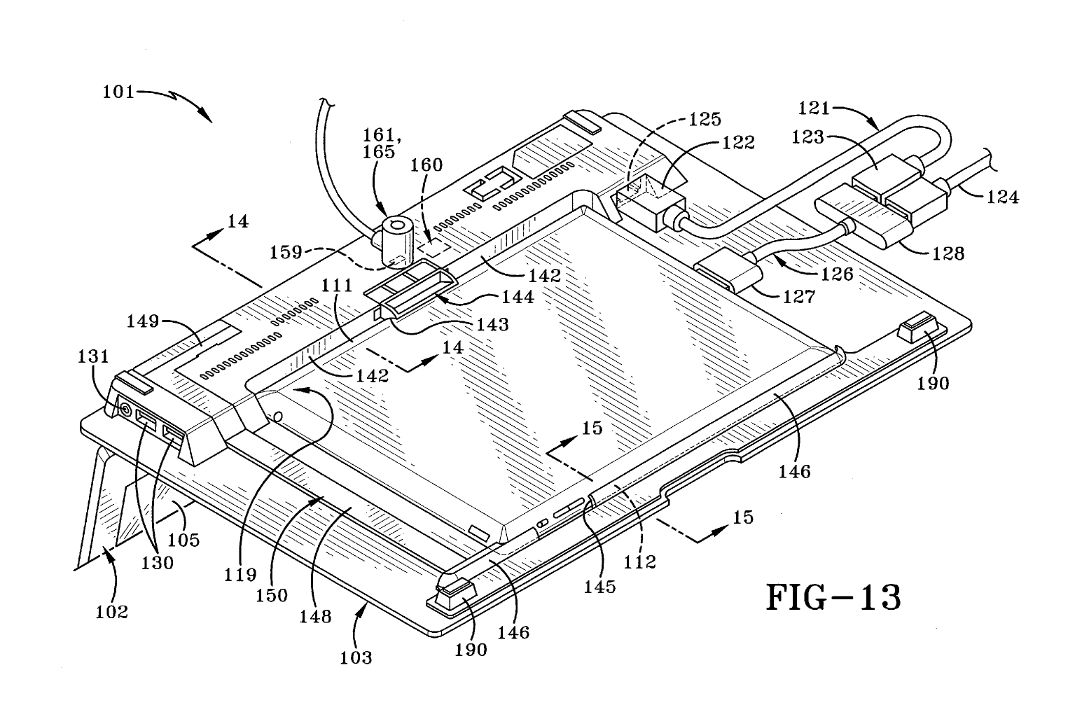

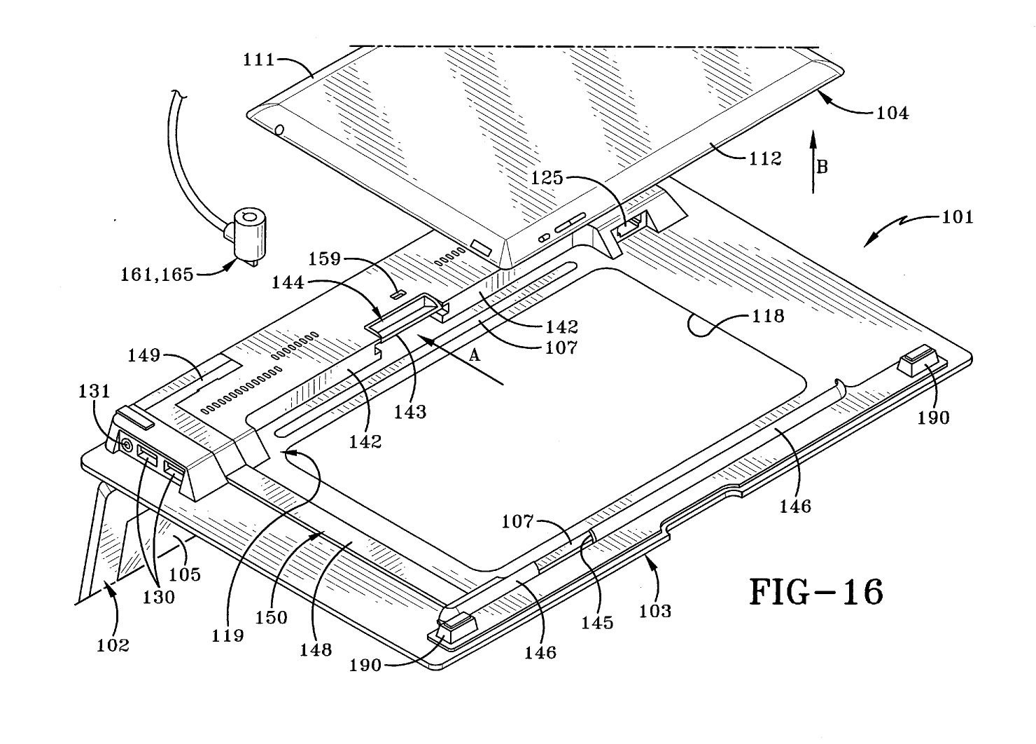

As best seen in FIG. 13, the base 103 includes a latch member 144 adjacent to back wall 142 of an electronic device chamber 119 in the base 103 as discussed further below. The latch member 144 includes a concave surface 143 that is formed complementary to a top edge surface 111 of the electronic device 104. In this embodiment, the base 103 has an electronic device chamber 119 (best seen in FIG. 16) into which the electronic device 104 can be inserted. The electronic device chamber 119 is formed in part by the back wall 142 of the base 103, a front interior wall 146 of the base 103 and a bottom surface of the base 103. A perimeter of the upper surface of the base 103 is formed to create an open window 118 that is an opening so that a screen of the electronic device 104 can be viewed when it is inserted into the electronic device chamber 119. The electronic device 104 is inserted into the chamber 119 from the bottom of the base 103. A front end 112 of the electronic device 104 is placed into a concave area formed by a concave surface 145 on the interior front wall 146. Next, as discussed later, a back wall (e.g. top surface 111) of the electronic device 104 is locked into place with the latch member 144. The upper surface of the electronic device 104 presses the perimeter of the upper surface of the base 103 that forms the open window 118 to aid in keeping the electronic device 104 within the chamber 119

In this configuration of this embodiment, the base 103 can include a lock opening 159. A lock mechanism 165 can be inserted into the lock opening 159 to lock the latch member 144 in a locked position preventing removal of the electronic device 104 from the base 103 and securing the portable monitor 101 in a locked configuration to prevent theft of the portable monitor 101. The lock mechanism 165 may be, for example a “Kensington” 161 type of locking mechanism. Alternatively, in other configurations, the base 103 can have an internal locking mechanism 160 that can be locked with a key. Those of ordinary skill in the art will realize that any other suitable device or other methods of locking the latch member 144 and the base 103 can be used.

In use, the bottom edge surface 112 is first positioned into concave surface 145 the concave front wall 146. Next, the latch member 144 is pushed in the direction of arrow A in FIG. 16 and top surface 111 of electronic device 104 is placed within the latch member 144 so that it is locked between the latch member 144 and other surfaces of base 103. A spring bias can be used to return the latch member 144 to a latched position that holds the electronic item within the base 103. The lock mechanism 165 can then be used to lock the latch member 144 so that it cannot release the electronic device 144. Later the lock mechanism 165 can be unlocked and then the latch member can again be pushed in the direction of arrow A to release the electronic device 104 allowing the electronic device 104 to be moved in the direction of arrow B to remove it from the base 103.

The portable monitor 101 includes a screen device 102 attached to base 103 with a universal hinge 120 (e.g., compound hinge) similar to the universal hinge described earlier. The base 103 forms a housing that is used to support the screen device 102 that includes a screen 105 for displaying image data. The screen 105 can be 15.6 inches, 17.3 inches or another size. The screen device 102 generally surrounds the display 105 to protect the display 105 from being scratched or damaged while the portable monitor 101 is transported. As discuss above, the base 103 can be formed similar to the housing used in a traditional laptop computer. The base 103 should be shaped and have enough weight to support and balance the screen device 102 when in the open position as shown in FIG. 10. The base 103, screen device 102, and other components of the portable monitor display are generally formed of rigid plastic, polymer-based materials, or a metal such as aluminum but other materials can be used. One implementation of this embodiment uses a sheet of aluminum to form the upper surface of the base 103.

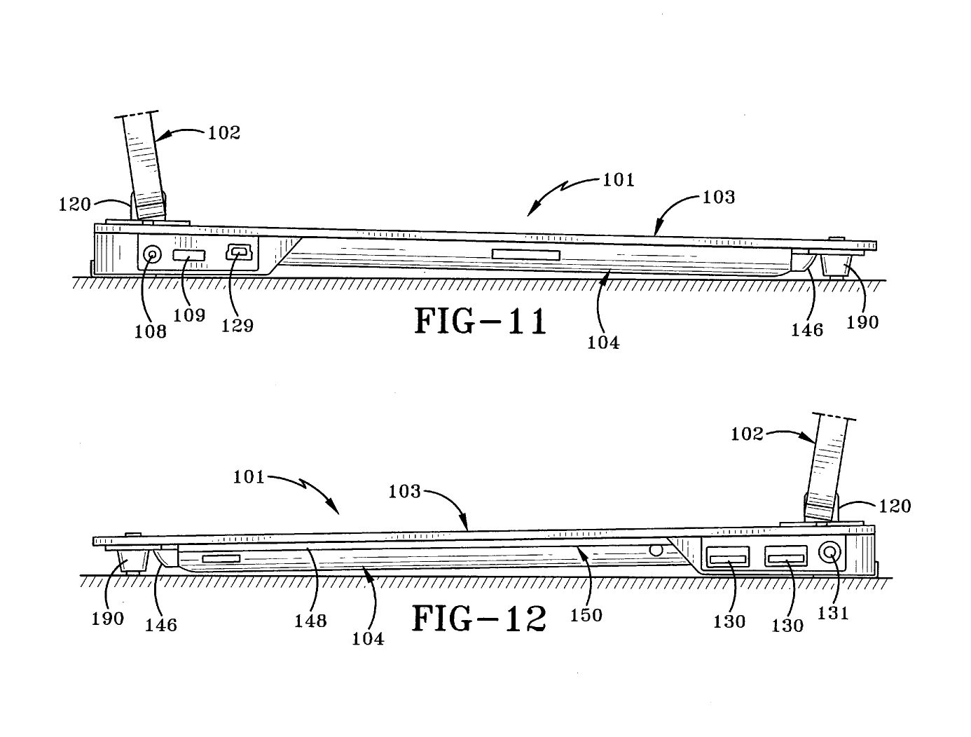

As shown in FIGS. 11 and 12, the right side of the base 103 can have one, two or more universal serial bus (USB) ports 130 and an audio output port 131. The left side is illustrated with a variety of other ports 129 that can include a USB-B port, an audio jack (output) or other auxiliary ports. Of course, the ports on the left side and the right side of the base 103 can be located at different locations on the portable monitor 101. This embodiment also includes a video port (connector, interface) 125 on the underside (see FIG. 13) of the base 103 to allow the video of the electronic device 104 to be displayed on a screen 105 of the screen device 102. The video port 125 can be a high definition multiple interface (HDMI) type of port. A single cable 121 can be used to connect the electronic device 104 to the base 103. Even though FIG. 13 is illustrated with the cable 121 in a daisy chain configuration that allows the portable monitor to be daisy chained together with one or more other monitors, a first end 122 of the cable 121 could be connected into the video input port 125 of the portable monitor 101 and a second end 123 of the cable could be directly connected to the electronic device 104.

As shown in FIG. 13, a power cable 124 can be used to power the electronic device 104. In this configuration, a first end 127 of a 30 conductor cable 126 is connected to the electronic device 104. A second end 128 with dual connectors is connected to a power cable 124 and a first end 123 of a video cable 121. The second end 122 of the video cable is connected to a video port 125. Also, in the portable monitor 101 can be powered by receiving power from cable 124 and then through cable 121. Some configurations of this embodiment can include a battery to provide power to the portable monitor 101.

As understood by those with ordinary skill in the art, other displays could be daisy chained together by plugging a second display into one of the USB ports 130. Additionally, an HDMI output port can be installed on in the portable monitor 101 to allow daisy chaining of the monitor from the HDMI output port to other monitors. In addition to daisy chaining it is possible to drag content from the electronic device 104 onto the screen 105 of the portable monitor 101.

As previously mentioned, the screen device 102 and the base 103 are connected together with a universal hinge 120 attached to the bottom side of the screen device and the base 103 that also allows the portable monitor 101 to be configured into a tablet display as discussed later. The base 103 also includes an L-shaped rear support brace 150 as shown in FIG. 13 but this brace can also be U-shaped or other shapes. The rear support brace 150 includes an elongated arm 148 and a cross-arm 149. Similar to the support brace 50 of the preferred embodiment discussed earlier, in the “laptop display position” of FIG. 10, the rear support brace 150 is folded under the base 103 and is not used because the base 103 acts to support the screen device. Similar to the preferred embodiment, the screen device 102 can be rotated about its universal hinge 120 and then folded into a tablet type of display position. Alternatively, the rear support brace 150 can be extracted from the bottom surface of the base 103 so that the portable monitor 101 can be tilted forward and used as an upright monitor as shown in either a portrait or a landscape position.

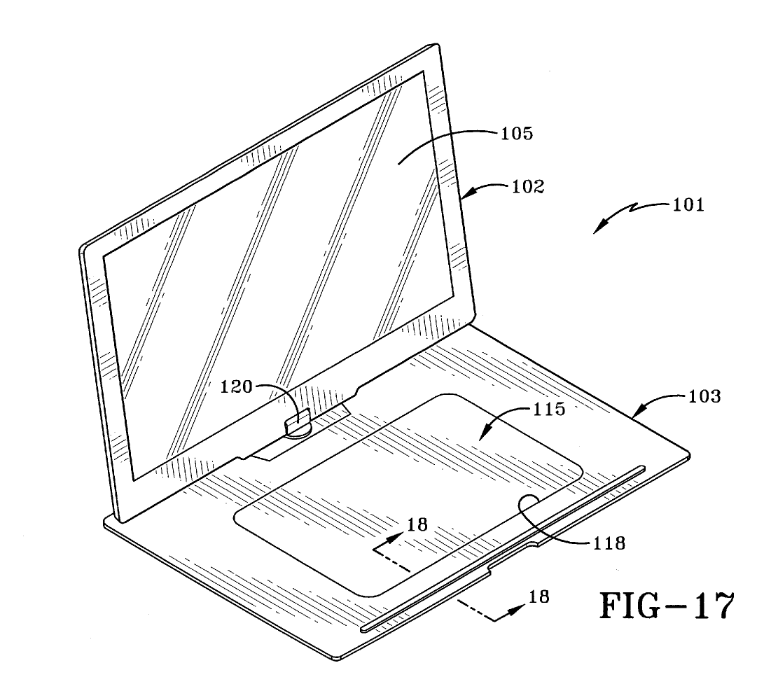

This embodiment can include a blank “plug” 115 as shown in FIG. 17. The blank plug 115 can be inserted into the opening 118 of base 103 instead of the electronic device 104. For example, this plug 115 can be snap-fitted into the opening 118, locked into the electronic device chamber 119 with latch device 144 or placed into the opening 118 in other ways. This blank plug 115 can be used by individuals who desire using the portable screen 101 with another device plugged into it without having an electronic device 104 plugged into the base 103. The blank plug 115 is formed of inexpensive plastic or other material and shaped similar to an electronic device that would be inserted into the electronic device chamber 119 and locked in place by the latch member 144. This allows the portable monitor 101 to appear attractive when an electronic device is not inserted into the base 103.

Some configurations of the portable monitor 101 of this embodiment can include a touchpad/keypad combination unit 134 as shown in FIG. 17. The touchpad/keypad combination unit 134 makes it easy for those who input a lot of numerical data to use a standard keypad with a laptop computer or other device connected to the portable monitor 101. For example, the touchpad/keypad combination unit 134 can be plugged into a computer and used by itself with the computer without using the portable monitor 101. Alternatively, the touchpad/keypad combination unit 134 can be plugged into a computer where the computer is connected to the portable monitor 101. In another alternative use, the touchpad/keypad combination unit 134 can be inserted into the electronic device chamber 119 and used to input data from there.

The touchpad/keypad combination unit 134 includes a touch pad 135 and a keypad 136 adjacent to one another. The touchpad 135 is shown as being left of the keypad 136, but the touchpad 135 and keypad 136 could be located in other positions relative to one other.

The touchpad 136 is shown with two buttons 170 but could include a different number of buttons 170. In operation, the touchpad 135 can be used to interact with images generated on the screen 105 using a mouse pointer or another graphical interface. The buttons 170 can be used to select items displayed on the screen 105 or to interact with images presented on the screen in other ways as understood by those with ordinary skill in the art.

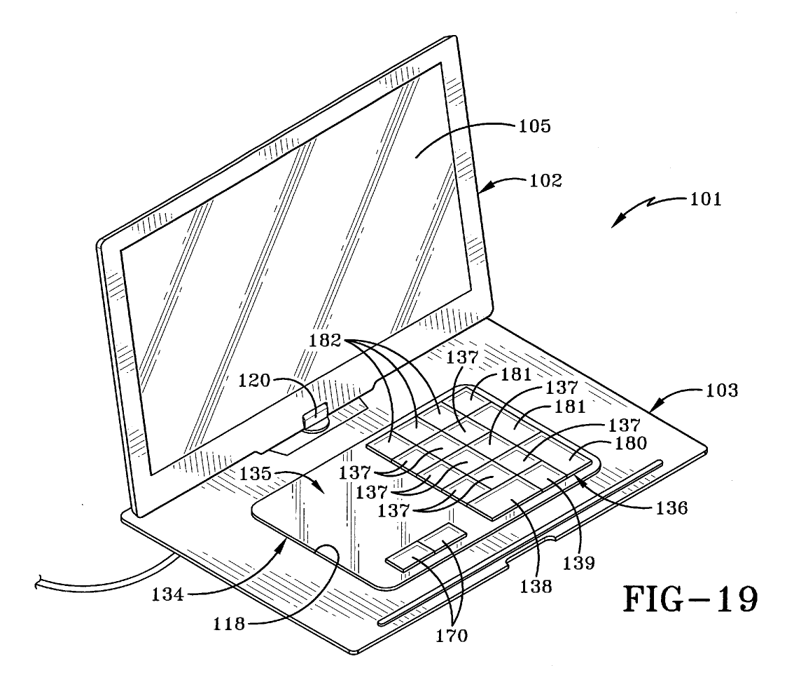

The keypad 136 is shown with a variety of buttons (e.g., keys) 137, 138, 139, 180, 181 and 182, but could also include different kinds of buttons or buttons in different locations on the keypad 136 than what is illustrated. In general, the keypad 136 is generally configured as a “standard” keypad that is a common keypad favored for inputting numeric values into an electronic device. The keypad of FIG. 19 is illustrated with keys 137 for entering numbers 1 through 9 as well as a key 138 for entering the number “0”. Key 139 is used for entering a decimal point when entering a fractional portion of a number. Two keys 181 are used to input mathematical operation such as “plus” (+) and “minus” (−) while keys 182 can be used to represent the “number lock”, “slash” (/) and “asterisks” (*).

This embodiment of the portable monitor 101 can include other useful features. For example, the base 103 can include front post structures 190 used to support the front of the base 103. A rear housing structure is used to support the rear portion of the base 103 so that there is some downward taper of an upper surface of the base toward the front post structures 190. The rear housing structure 191 can have the latch member 144, video port 125, audio output port 131, USB ports 130, a power supply port 108, a power button 109 and other ports 129 such as a USB-B port. The portable monitor 101 can be configured so that it can be hung from a wall with a video electronics standards association (VESA) type of mounting device. Various pads 107 can be added to the portable monitor 101 to protect surfaces on the electronic device and/or the portable monitor 101.

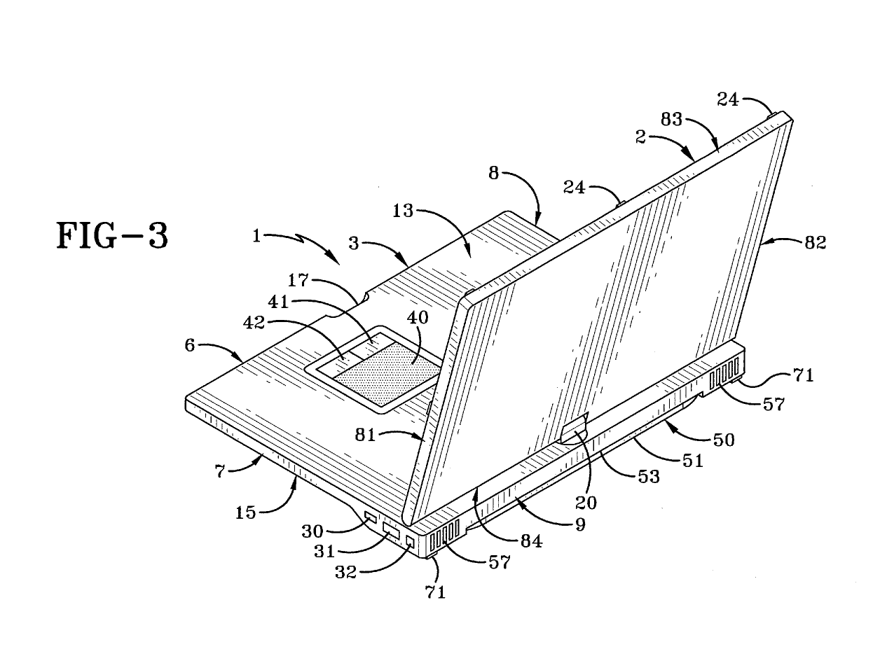

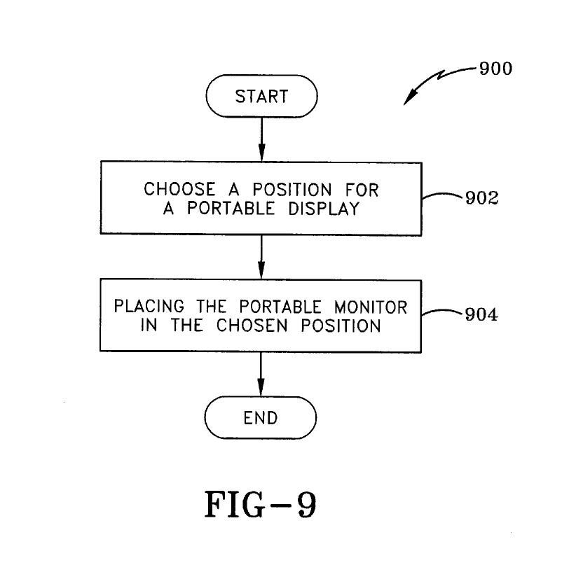

FIG. 9 illustrates a method 900 of using a portable display comprised of a monitor and a base. The portable display can lack a processor executing software instructions. In one configuration, the portable display can include a DisplayLink chip to process image data. The method 900 chooses, at 902, whether to place the portable display in a closed laptop position as shown in FIG. 2, an open laptop position as shown in FIGS. 1 and 3, a tablet computer position as shown in FIG. 6 or a freestanding monitor position as shown in FIGS. 7 and 8.

A universal hinge is connected to the base and monitor to orientate the portable display to be displayed in a closed laptop position, an open laptop position, a tablet computer position, or a freestanding monitor position. The monitor is planar and adjacent to the base with the display screen facing toward the base when the portable display is in the closed position. When the portable display is in the closed position, the base is generally horizontal to a horizontal surface and the monitor is opened away from the base to allow a user to view the display screen. The display is planar and adjacent to the base with a display screen facing outward from the base when the portable monitor is in the tablet position. The tablet computer position may be a traditional tablet computer position where the display is placed flat on a desk. Alternatively, the tablet computer position may be upright with the display leaning back on a stand supporting the display upright. The monitor and the base are placed, at 904, in the chosen position.

A display stand is pivotally attached to the display base, at 908. The display stand can be attached to the display base and may fold into or away from the base. The display stand can be U-shaped, L-shaped or other shapes and can be pivotally attached to the two ends of an U-shaped display stand. The display stand can be pivoted from the display base to support the portable display in an upward position when the portable display is in the tablet position.

Different modules can be attached to the display or swapped with other modules attached to the display. For example, different data entering devices can be attached to the display such as a numeric keypad, a full QWERTY keyboard for operation in a classroom/“zero client” setting.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

Moreover, the description and illustration of the invention is an example and the invention is not limited to the exact details shown or described. References to “the preferred embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in the preferred embodiment” does not necessarily refer to the same embodiment, though it may.

What is claimed is:

1. A portable monitor comprising:
a monitor base with a top surface and a bottom surface;
a monitor device attached to the monitor base including a video screen, wherein the video screen is configured to display video data received from a device external to the portable monitor;
an opening in the monitor base configured to accept an electronic device that fits at least partially within the opening; and
a latching member configured to latch the electronic device to the monitor base.

2. The portable monitor of claim 1 further comprising:
a locking device configured to lock the portable monitor and the electronic device together.

3. The portable monitor of claim 2 wherein the locking device is configured to secure the portable monitor and the electronic device to a secure location and prevent the theft of the portable monitor and the electronic device from the secure location.

4. The portable monitor of claim 2 wherein the locking device is a Kensington type of locking device that locks to both the portable monitor and the electronic device.

5. The portable monitor of claim 1 further comprising:
a locking device configured to lock the electronic device to the portable monitor so that the electronic device cannot be removed from the portable monitor.

6. The portable monitor of claim 1 wherein the electronic device is one of the group consisting of: an iPad®, an iPhone®, iPod Touch®, a tablet computer, a cellular phone and a handheld electronic device.

7. The portable monitor of claim 1 wherein the opening is an opening that extends completely through the monitor base from the top surface through the bottom surface.

8. The portable monitor of claim 1 further comprising:
a connector allowing the electronic device to be connected to the portable monitor so that what is displayed on the electronic device is also displayed on the monitor device of the portable monitor.

9. The portable monitor of claim 8 further comprising:
a cable for connecting the electronic device to the connector.

10. The portable monitor of claim 8 wherein the connector is one of the group consisting of: a high definition multiple input (HDMI) type of connector and universal serial bus (USB) type of connector.

11. The portable monitor of claim 8 wherein the connector is configured to allow one or more other computer monitors to be daisy chained together with the portable monitor.

12. The portable monitor of claim 11 wherein the one or more other computer monitors to be daisy chained together allows for a working graphical area of the electronic device to be spread out among the one or more other computer monitors to be daisy chained together.

13. The portable monitor of claim 1 wherein the portable monitor is configured to be stood upright on a generally horizontal surface at different times in both landscape and portrait configurations.

14. The portable monitor of claim 1 wherein the portable monitor is configured to be hung with a video electronics standards association (VESA) mounting bracket.

15. The portable monitor of claim 1 further comprising:
a filler unit adapted to fit into the opening in place of the electronic device so that the surface of the monitor base is generally smooth and flat.

16. The portable monitor of claim 15 further comprising:
a connector adapted to allow a computing device to be connected to the portable monitor when the filler unit is installed in the opening, wherein the computing device controls the monitor device when the computing device is connected to the portable monitor.

17. The portable monitor of claim 1 further comprising:
a keypad device including numeric keys and a touchpad located adjacent the numeric keys, wherein the keypad device is adapted to fit into the opening in place of the electronic device, and wherein the touchpad is configured to allow a user to move a curser displayed on the monitor device and wherein the numeric keys allow the user to enter numeric values to an application displayed on the monitor device.

18. The portable monitor of claim 1 wherein the keypad device does not include any alphabetical keys.

19. The portable monitor of claim 1 further comprising:
a universal hinge connecting the monitor base to the monitor device, wherein the universal hinge is configured to position the monitor base and the monitor device in a first position that is a closed position with the video screen facing the monitor base, wherein the universal hinge is configured to position the monitor base and the monitor device in a second position that is an open position with the monitor device opened away from the monitor base so that the video screen is in a position for viewing by a user of the portable monitor, and wherein the universal hinge is configured to position the monitor base and the monitor device in a tablet computer position with the monitor device folded against the monitor base with the video screen facing away from the monitor base for viewing by a user of the portable monitor; and
wherein a rear support brace is carried by the portable monitor to support the portable display when the portable display is in the tablet computer position.

20. An input device comprising:
a keypad with numeric keys adapted to enter digits into at least one of the group of: a software application and an electronic device;
a touch pad adjacent the keypad adapted to control a pointer on an electronic display; and
wherein the input device does not have alphabetical keys.
